(19) United States
(12) Patent Application Publication
(10) Pub. No.: US 2019/0145554 A1
(43) Pub. Date: May 16, 2019

(54) ANTI-TWIST WATER-SAVING PERMEABLE HOSE

(71) Applicant: Zhangzhou Leyuan Industrial Co., Ltd., Zhangzhou (CN)

(72) Inventor: Wen Li Kuo, Zhangzhou (CN)

(21) Appl. No.: 15/810,149

(22) Filed: Nov. 13, 2017

(51) Int. Cl. F16L 11/12; A01G 25/02

(52) U.S. Cl. CPC F16L 11/121; A01G 25/06; A01G 25/02

(57) ABSTRACT

An anti-twist water-saving permeable hose is provided. A wall of the permeable hose has two curved support portions and two permeable portions connected between the two support portions. The permeable portions are mated with the support portions to form a flat chamber. The permeable portions have a curvature greater than that of the support portions. The support portions have a hardness value greater than that of the permeable portions, so that the support portions and the permeable portions are still able to cooperate with each other to form the chamber when the permeable hose is bent. Thus, the permeable hose does not twist to ensure its service life.

### BACKGROUND OF THE INVENTION

### 1. Field of the Invention

The present invention relates to an irrigation hose, and more particularly to an anti-twist water-saving permeable hose.

### 2. Description of the Prior Art

For irrigation, a porous permeable hose is laid on the ground or embedded under the ground. Through water pressure, water is supplied to various irrigation hoses, which makes the soil keep stable humidity so that the plant roots can fully absorb water so as to save irrigation water and to enhance crop capacity.

As shown in FIG. 1 and FIG. 2, a conventional circular permeable hose 20 is made of a porous material. The circular permeable hose 20 has the following problems:
1. In order to make irrigation more fully, the permeable hose is laid on the ground and embedded under the ground in a curved manner. During irrigation, the bent portion of the permeable hose is prone to twist, so the liquid cannot flow through the entire permeable hose, making irrigation uneven. After the permeable hose is bent, the water pressure in the section from the water inlet to the bent portion of the permeable hose will increase. The great water pressure may cause the permeable hose to burst or crack. As a result, the permeable hose cannot be used. In addition, even though the twist of the permeable hose can be found in time, the strength of the bent portion of the permeable hose will be damaged, thus affecting the service life of the permeable hose.
2. When the water pressure in the permeable hose increases, the wall of the permeable hose expands. Because the permeable hose is round, the expansion of the permeable hose is not easy to find. Only the water pressure in the permeable hose reaches a certain value and the expansion of the permeable hose reaches a certain degree, the user will find the water pressure in the permeable hose is too high. If the user controls the water pressure in the permeable tube in time, the strength of the permeable hose will be affected, thereby reducing the service life of the permeable hose.
3. The permeable hose is usually coiled for transportation. Because the permeable hose is in a circular shape, the volume of the permeable hose after coiled is large, increasing the cost of transportation.

Accordingly, the inventor of the present invention has devoted himself based on his many years of practical experiences to solve these problems.

### SUMMARY OF THE INVENTION

In view of the shortcomings of the prior art, the primary object of the present invention is to provide an anti-twist water-saving permeable hose. The permeable hose does not twist to ensure its service life.

In order to achieve the aforesaid object, an anti-twist water-saving permeable hose is provided. A wall of the permeable hose has two curved support portions and two permeable portions connected between the two support portions. The permeable portions are mated with the support portions to form a flat chamber. The permeable portions have a curvature greater than that of the support portions. The support portions have a hardness value greater than that of the permeable portions. The permeable portions have permeation holes thereon.

Preferably, the permeable portions are in the form of a straight configuration. The permeable portions are mated with the support portions to form the flat chamber.

Preferably, the permeable portions have a length greater than an inner diameter of the support portions.

Preferably, the permeable portions are in the form of a curved configuration. The permeable portions are mated with the support portions to form an elliptical chamber.

Preferably, the support portions are provided with water permeable holes.

Preferably, the permeable portions are formed of a porous material.

Compared with the prior art, the present invention has the following beneficial effects:
1. The wall of the permeable hose of the present invention is formed by the support portions and the permeable portions. The hardness of the curved support portions is greater than that of the permeable portions, so that the support portions and the permeable portions are still able to cooperate with each other to form the chamber when the permeable hose is bent. Thus, the permeable hose does not twist during bending to ensure its service life.
2. Because the permeable hose is in the form of a flat configuration, the volume of the permeable hose is smaller than that of a circular permeable hose, so that the packing cost is low and the transportation space is also small, thereby reducing the transportation cost of the permeable hose.
3. If the permeable hose is in the form of an oval running track configuration, when the water pressure in the permeable hose rises, the permeable portions expand and are bulged outward relative to the support portions and the shape of the permeable hose changes significantly. It is easy for the user to visually determine whether or not the water pressure in the permeable hose exceeds the limit by the shape of the permeable hose during the use of the permeable hose, thereby achieving effective control of the water pressure in the permeable hose.

### BRIEF DESCRIPTION OF THE DRAWINGS

FIG. 1 is a front view of a conventional permeable hose;

FIG. 2 is a sectional view of the conventional permeable hose;

FIG. 3 is a front view of the permeable hose of the present invention;

FIG. 4 is a sectional view of the permeable hose of the present invention;

FIG. 5 is a schematic view of the permeable hose of the present invention in a use state;

FIG. 6 is a schematic view of the permeable hose of the present invention in a coiled state;

FIG. 7 is a schematic view of the conventional circular permeable hose in a coiled state;

FIG. 8 is a top view of FIG. 6;

FIG. 9 is a top view of FIG. 7;

FIG. 10 is a front view of FIG. 6; and

FIG. 11 is a front view of FIG. 7.

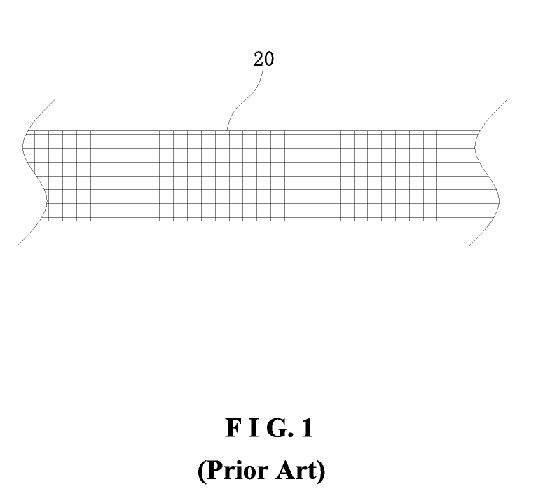

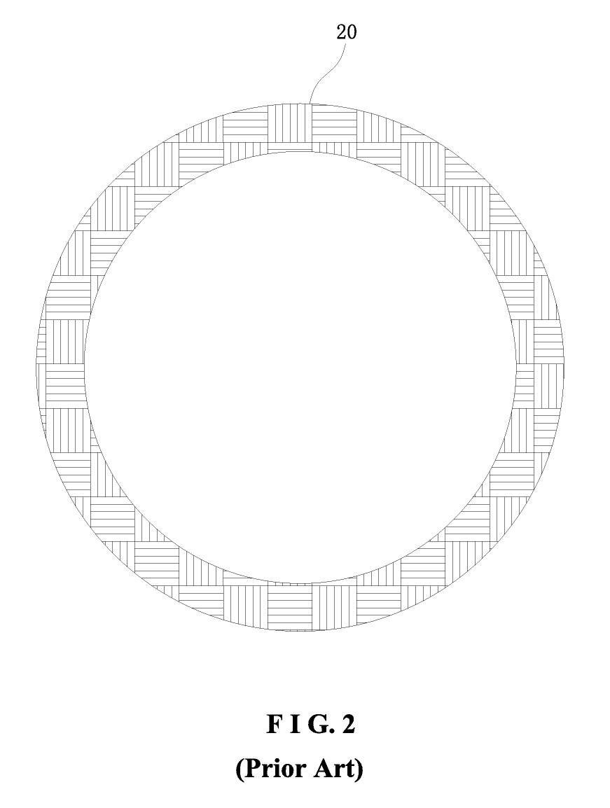

### DETAILED DESCRIPTION OF THE PREFERRED EMBODIMENTS

Embodiments of the present invention will now be described, by way of example only, with reference to the accompanying drawings.

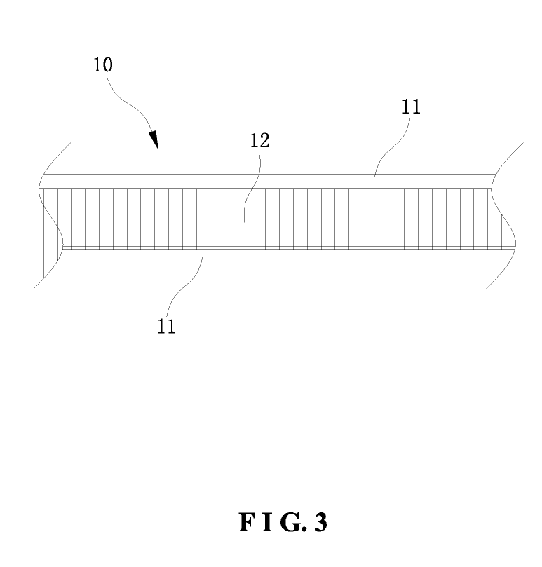

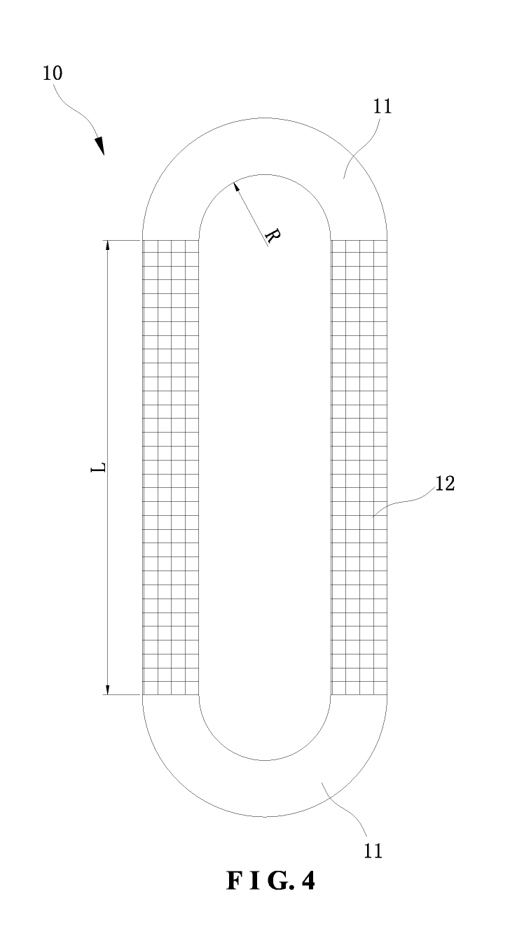

As shown in FIG. 3 and FIG. 4, the present invention discloses an anti-twist water-saving permeable hose 10. The anti-twist water-saving permeable hose 10 has two curved support portions 11 and two permeable portions 12 connected between the two support portions 11. The permeable portions 12 are mated with the support portions 11 to form a flat chamber. The permeable portions 12 have a curvature greater than that of the support portions 11. The support portions 11 have a hardness value greater than that of the permeable portions 12. The permeable portions 12 have permeation holes thereon.

The permeable portions 12 may be formed of a porous material. The pores of the porous material are the permeation holes. The permeable portions 12 may be formed of a water-proof material. The permeation holes of the permeable portions 12 are through holes provided on the material.

The permeable portions 12 may be a straight configuration. The permeable hose 10 is an oval running track configuration. The chamber formed by the permeable portions 12 and the support portions 11 is a flat chamber. The length L of the permeable portions 12 is greater than the inner diameter R of the support portions 11 in order to ensure the permeation amount of the permeable hose 10. Furthermore, the support portions 11 of the permeable hose may be provided with water permeable holes.

The permeable portions 12 may have a curved configuration. The chamber formed by the permeable portions 12 and the support portions 11 is an elliptical chamber. The permeable hose of this configuration can also solve the problems existing in the prior art.

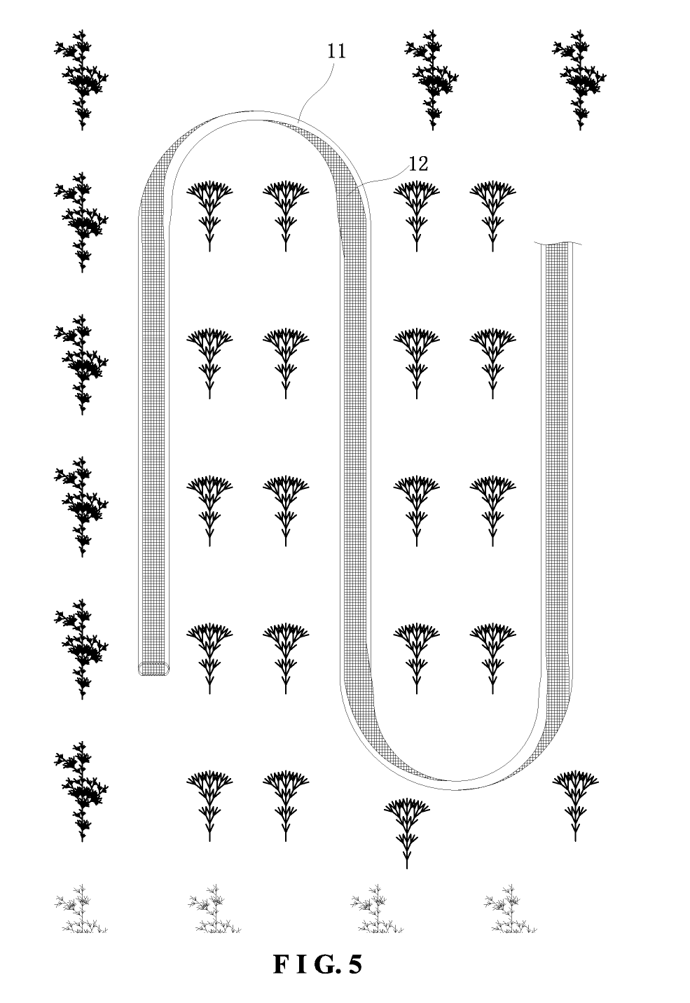

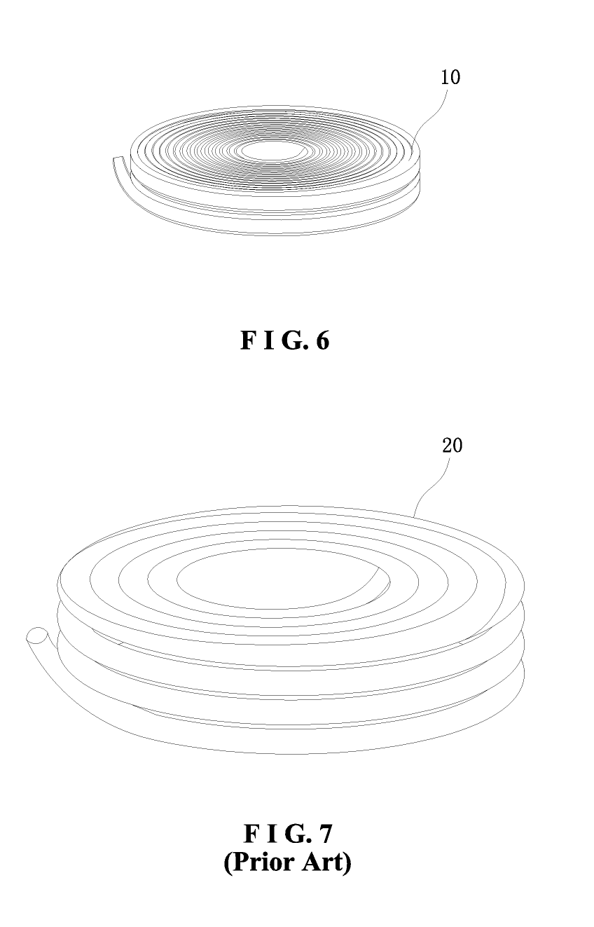

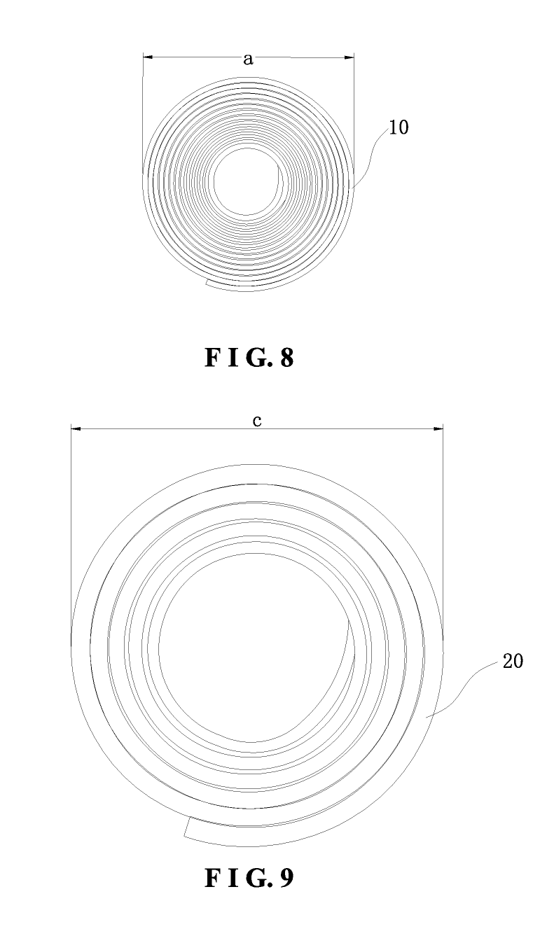

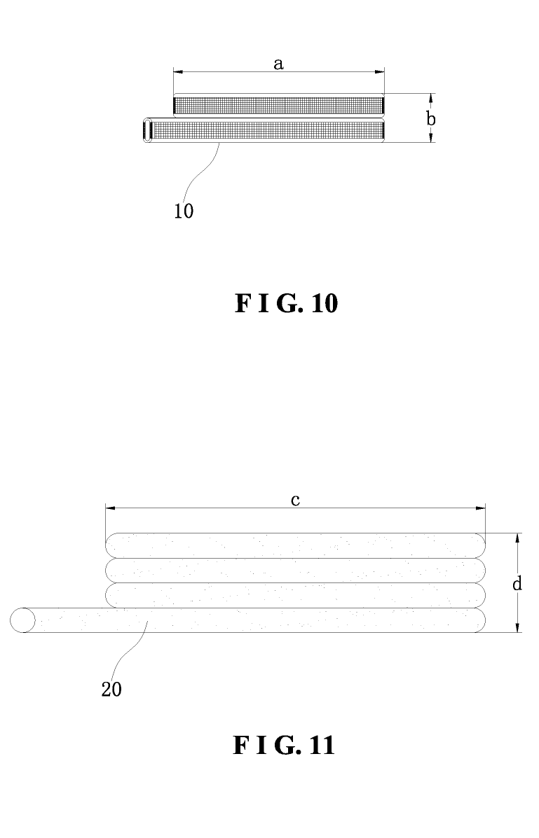

After the production of the permeable hose 10 of the above structure is completed, the permeable hose is coiled and packed and transported to the use site. As shown in FIG. 6 to FIG. 11, since the permeable hose 10 has a flat configuration, the coiled diameter a of the permeable hose 10 of the present invention is less than the coiled diameter c of the circular permeable pipe 20 of the prior art. The coiled height b of the permeable hose 10 of the present invention is less than the coiled height d of the circular permeable pipe 20 of the prior art. In summary, compared with the prior art, the permeable hose 10 of the present invention has a small volume after coiled, so that the packaging cost is low and the transportation space occupied is small, thereby reducing the transportation cost of the permeable hose 10.

As shown in FIG. 5, before the permeable hose 10 is used for irrigation, the permeable hose 10 is laid on the ground or embedded under the ground in a curved manner. In the straight laying section, the permeable portions 12 of the permeable hose 10 is in contact with the ground and the two support portions 11 are located at both sides. In the curved laying section, when the permeable hose 10 is subjected to a bending force, the permeable portions 12 are forced to bend only when the curvature of the support portions 11 changes greatly. Since the hardness value of the support portions 11 of the permeable hose 10 of the present invention is greater than the hardness value of the permeable portions 12. The hardness of the support portions 11 is large and the curvature of the support portions 11 cannot be greatly changed. Therefore, when the permeable hose 10 is subjected to a bending force, the support portions 11 gradually stand on the ground. The permeable portions 12 and the support portions 11 are still able to cooperate with each other to form the chamber due to the small change in the curvature of the support portions 11. Thus, the permeable hose 10 does not twist to ensure its service life.

When the permeable hose 10 is an oval running track configuration, the water or nutrient solution flowing through the permeable hose 10 is exuded out from the permeable portions 12 when the permeable hose 10 is used for irrigation. When the water pressure in the permeable hose 10 rises, the permeable portions 12 expand and are bulged outward relative to the support portions 11, and the shape of the permeable hose 10 changes significantly. It is easy for the user to visually determine whether or not the water pressure in the permeable hose exceeds the limit by the shape of the permeable hose during the use of the permeable hose 10, thereby achieving effective control of the water pressure in the permeable hose.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An anti-twist water-saving permeable hose, a wall of the permeable hose having two curved support portions and two permeable portions connected between the two support portions, the permeable portions being mated with the support portions to form a flat chamber, the permeable portions having a curvature greater than that of the support portions, the support portions having a hardness value greater than that of the permeable portions, the permeable portions have permeation holes thereon.

2. The anti-twist water-saving permeable hose as claimed in claim 1, wherein the permeable portions are in the form of a straight configuration, and the permeable portions are mated with the support portions to form the flat chamber.

3. The anti-twist water-saving permeable hose as claimed in claim 2, wherein the permeable portions have a length greater than an inner diameter of the support portions.

4. The anti-twist water-saving permeable hose as claimed in claim 1, wherein the permeable portions are in the form of a curved configuration, and the permeable portions are mated with the support portions to form an elliptical chamber.

5. The anti-twist water-saving permeable hose as claimed in claim 1, wherein the support portions are provided with water permeable holes.

6. The anti-twist water-saving permeable hose as claimed in claim 1, wherein the permeable portions are formed of a porous material.
